(19) United States
(12) Patent Application Publication
(10) Pub. No.: US 2009/0114460 A1
(43) Pub. Date: May 7, 2009

(54) Biped Mobile Mechanism

(75) Inventors: Azusa AMINO, Hitachinaka (JP); Junichi TAMAMOTO, Kasumigaura (JP); Ryosuke NAKAMURA, Hitachinaka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi, Ltd.

(21) Appl. No.: 12/264,969

(22) Filed: Nov. 5, 2008

(30) Foreign Application Priority Data
Nov. 5, 2007 (JP) 2007-286864

(51) Int. Cl. B62D 57/028

(52) U.S. Cl. 180/8.3; 901/1

(57) ABSTRACT

A robot having a leg mechanism having high rigidity, so as to enable moving on wheels, on the leveled ground, and also moving on the bipedalism, on the unleveled ground, and also enabling to execute exchanging between the wheel running and the bipedalism in a short time, comprising: a body; and left and right leg portions in lower portion of the body, wherein each leg portion has a wheel, which can be drive, at a tip thereof, and a supporting portion, which is movable in roll and pitch directions, the each leg portion has three (3) degrees of freedom, roll, pitch and pitch from the body side, and the supporting portion has at least two (2) of contact points to be in contact with a ground, and makes up a stable region by a contact point of the wheel and the contact point of the supporting body, and thereby oscillating the left and right leg portions, alternately, so as to make bipedalism, and further operating the supporting body, so as to run on the wheels.

### BACKGROUND OF THE INVENTION

The present invention relates to a robot equipped with a mobile apparatus, in particular, a mobile capacity, for automatically conducting an operation or work to be a target.

In relation to a robot having a mobile mechanism for enabling to move on a level ground or an unleveled ground, a humanoid robot is disclosed in the following Patent Document 1. In this Patent Document 1 is disclosed the humanoid robot, equipped with a driving wheels at portion corresponding to the soles of feet, so that it can run on the level ground, by means of the wheels through conducting an inverted pendulum control, while on the unleveled ground, with using the side surfaces of the feet as the soles, by turning roll shafts of ankles by 90 degrees, thereby conducting bipedalism.

[Patent Document 1] Japanese Patent Laying-Open No. 2005-288561 (2005).

### BRIEF SUMMARY OF THE INVENTION

However, with such the method as was mentioned above, because of much degrees of freedom to be passed through, from the wheels up to a trunk, there is a possibility of shortage of stiffness or rigidity at the toes when running on the wheels. Also, when switching between the running on the wheels and the bipedalism, it is necessary to change the condition of the wheels to touch on the ground, and therefore the time necessary for transition thereof comes to be long.

An object, according to the present invention, is to provide a robot, for achieving a leg mechanism having high rigidity, so as to enable moving on the wheels, on the leveled ground, and also moving on the bipedalism, on the unleveled ground, and further that mechanism can be switched between the on-wheel running and the bipedalism.

For accomplishing the object mentioned above, according to the present invention, there is provided a robot, comprising: a body; and left and right leg portions in lower portion of said body, wherein each leg portion has a wheel, which can be drive, at a tip thereof, and a supporting portion, which is movable in roll and pitch directions.

Also, for accomplishing the object mentioned above, according to the present invention, within the robot described in the above, said each leg portion has three (3) degrees of freedom, roll, pitch and pitch from said body side.

Also, for accomplishing the object mentioned above, according to the present invention, within the robot described in the above, said supporting portion has at least two (2) of contact points to be in contact with a ground, and makes up a stable region by a contact point of said wheel and the contact point of said supporting body, and thereby oscillating said left and right leg portions, alternately, so as to make bipedalism, and further operating said supporting body, so as to run on said wheels.

And also, for accomplishing the object mentioned above, according to the present invention, within the robot described in the above, a distance of a roll rotation shaft of said supporting body from a ground is so determined that the roll rotation shaft of said supporting body comes to be in parallel with said ground when at least two (2) points, including, are in contact with the ground, and also said roll rotation shaft of said supporting body and a center of cross-section circle of said roll rotation shaft are constructed to be coincident with, and a pitch rotation shaft of said supporting body and a rotation shaft of said wheel are constructed to be coincident with each other.

According to the present invention mentioned above, it is possible to provide a leg mechanism having high rigidity, so as to enable moving on the wheels, on the leveled ground, and also moving on the bipedalism, on the unleveled ground, and further this mechanism provides a robot enabling to execute exchanging between the wheel running and the bipedalism in a short time.

### BRIEF DESCRIPTION OF THE SEVERAL VIEWS OF THE DRAWING

Those and other objects, features and advantages of the present invention will become more readily apparent from the following detailed description when taken in conjunction with the accompanying drawings wherein:

FIG. 1 is an entire structural view of a robot, according to an embodiment of the present invention;

FIG. 2 is a view for explaining the degree freedom of leg portions of the robot, according to the embodiment of the present invention;

FIG. 3 is a perspective view for explaining the structures of the leg portions of the robot, according to the embodiment of the present invention;

FIG. 4 is a perspective view for explaining the structures of the leg portions of the robot under the inverted condition thereof, according to the embodiment of the present invention;

FIG. 5 is a perspective view for explaining the operations of a supporting body of the robot, according to the present invention;

FIG. 6 is a plane vide for showing FIG. 4 in the X-axis direction;

FIG. 7 is a plane vide for showing FIG. 4 in the Y-axis direction;

FIGS. 8A to 8D are views for explaining about the grounding condition when driving the supporting body into a roll direction; and

FIGS. 9A to 9D are views for explaining about the grounding condition when driving the supporting body into a pitch direction.

### DETAILED DESCRIPTION OF THE PREFERRED EMBODIMENTS

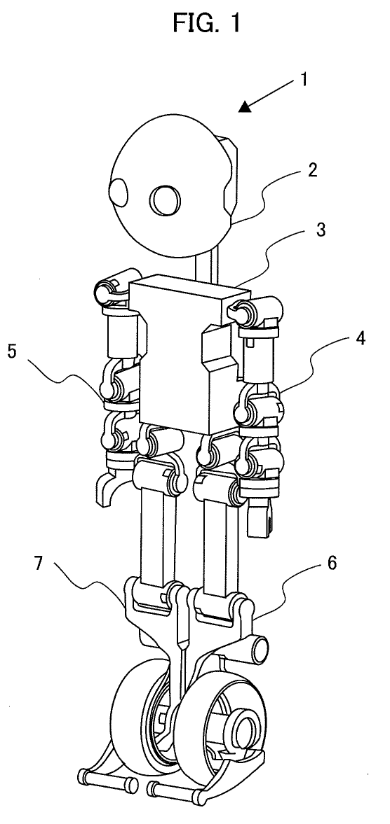

Hereinafter, an embodiment according to the present invention will be fully explained by referring to FIGS. 1 to 9 attached herewith.

FIG. 1 is an entire structural view of a robot, according to an embodiment of the present invention.

In FIG. 1, a robot 1 according to the present invention has two (2) pieces of leg portions, i.e., a left foot 6 and a right foot 7, and a body 3 above them. On both sides of the body 3, it has two (2) pieces of arm portions, i.e., a left arm 4 and the right arm 5. Also, above the body 3 is provided a head portion 2. For example, the left foot 6 and the right foot are used for movement of the robot 1, and the left arm 4 and the right arm 5 are used in workings or operations, such as, holding or grasping a matter, etc. The body 3 comprises a controller apparatus for controlling the operation of each portion, and sensors for detecting an inclination angle of the body to the direction of gravity and an angular velocity.

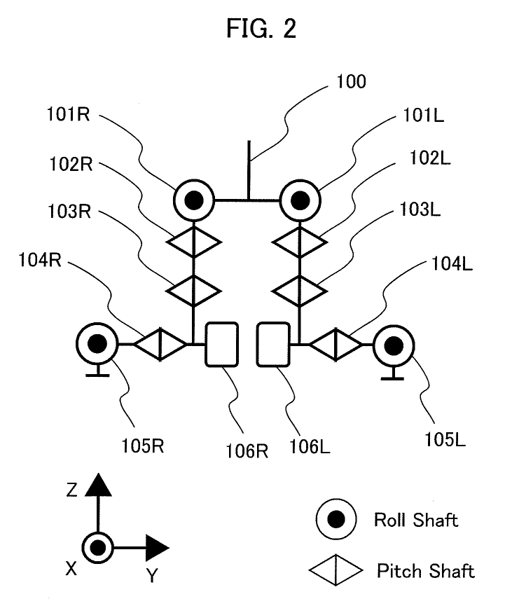

FIG. 2 is a view for explaining the degree freedom of leg portions of the robot, according to the embodiment of the present invention.

In FIG. 2, the robot 1 has five (5) pieces of joints and one (1) piece of wheel, for each of the left and right leg portions, i.e., the left foot 6 or the right foot 7. In the figure, a roll shaft means a shaft of rotating around the X-axis, and a pitch shaft means a shaft of rotating around the Y-axis. The left foot 6 and the right foot 7 have first roll joints 101L and 101R, first pitch joints 102L and 102R, second pitch joints 103L and 103R, respectively, from the body 100 side, and at the tips thereof, they comprise wheel joints 106L and 106R, support pitch joints 104L and 104R, and support roll joints 105L and 105R, in parallel.

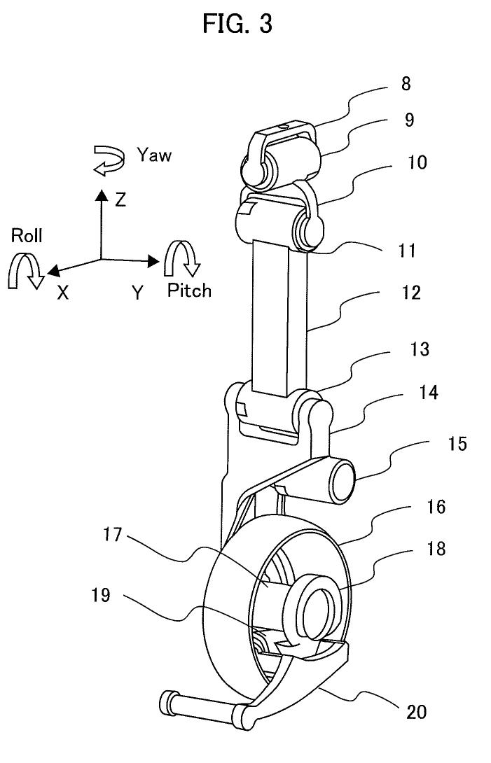

Each of the joints has a power source (i.e., a motor), a reduction gear and an angle detector (i.e., a rotary encoder or a potentiometer) built therein, and they drive parts connected therewith. The left foot 6 and the right foot 7 are equal to, in the constituent elements thereof, and the structures thereof are symmetric with an X-Z plane passing through the body 3, therefore in FIG. 3, explanation will be given only on the left foot 6.

FIG. 3 is a perspective view for explaining about the structures of leg portion, according to the present embodiment.

In FIG. 3, a first leg link 8 is connected with the body 3 at the upper end thereof, and at the lower end of the Z-axis is connected with a first leg actuator 9, having a driving axis rotating around the X-axis. The first leg actuator 9 is connected with a second leg link 10, and it oscillates or rocks the second leg link 10 by a predetermined angle around the X-axis. The second leg link 10 is connected with a second leg actuator 11, having a driving shaft rotating around the Y-axis, at the lower end thereof, and the second leg actuator 11 oscillates or rocks a third leg link 12 by a predetermined angle around the Y-axis. A third leg actuator 13 is attached at an end of a longitudinal side of the Z-axis, with respect to the connection between the second leg actuator 11 and the third leg link 12, and it oscillates or rocks a fourth leg link 14 by a predetermined angle around the Y-axis.

A wheel 16 is attached at a reverse end in the longitudinal direction of the Z-axis with respect to the connection of the third leg actuator 13 and the fourth leg link 14, to be freely rotatable in the Y-axis direction. A wheel driving actuator 15 can rotate infinitely, and is attached on the fourth leg link 14, thereby driving the wheel 16 through a belt, a shaft or a gear, etc., for example. A pitch shaft driving actuator 17 of the supporting body is attached on the fourth leg link 14, in coaxial with the wheel 16, and oscillates or rocks a support connection link 18 by a predetermined angle around the Y-axis. A roll shaft driving actuator 19 of the supporting body is attached on a support connection link 18, and oscillates or rocks the supporting body 20 by a predetermined angle around the X-axis. The wheel 16 is in a torus body having a circular cross-section, and is so formed that it is in contact with the ground, not on a line, but at a point.

In many cases, movement by the legs is conducted by controlling an attitude of the robot, in accordance with ZMP (Zero Moment Point), and thereby conducting walking. The ZMP is a center of reaction at the contacting point on the ground, and is a point on a floor surface where the moment due to the reaction comes to be zero (0). When the robot walks, there is necessity of conducting a walking control by taking an inertial force due to the movement of the robot itself, the gravity on the robot, the reaction force receiving from the floor, etc., into the consideration thereof. If production of a walking pattern in such a manner, that the ZMP installs itself within a supporting convex polygon by a foot sole of the robot, it is possible to make the robot walk without falling down. Thus, when conducting the bipedalism, it is preferable to form the supporting convex polygon as large as possible, by taking the stability into the consideration thereof.

The supporting body 20 is formed in the configuration extending in the X-axis direction and the Y-axis direction, and in an example shown in FIG. 3, the supporting convex polygon is so shaped by changing the attitude that it is in contact with the ground at least two (2) points or more than that, together with the wheels, and therefore this contributes to an increase of the stability when conducting the bipedalism.

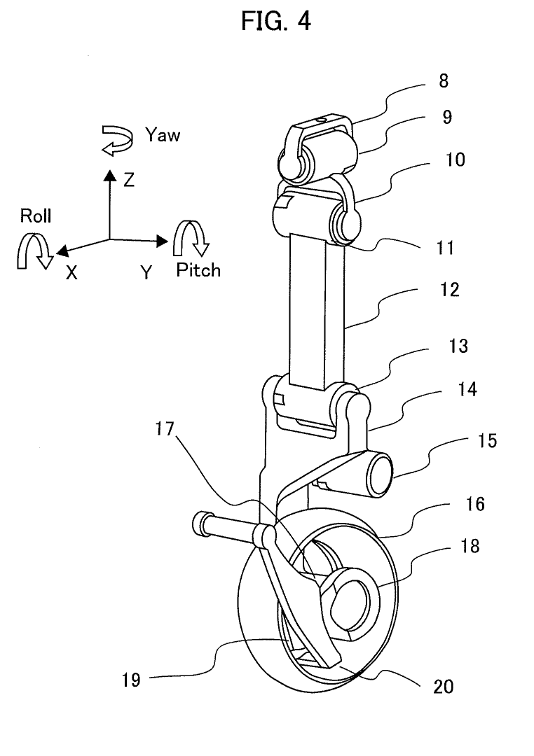

FIG. 4 is a perspective view for showing the leg portion under the inverted condition of the robot, according to the present embodiment.

In this FIG. 4, this leg portion is in the attitude when the robot moves on the wheels on a flatland, while conducting the inverted two (2) wheels control. As shown in FIG. 4, the pitch shaft driving actuator 17 of the supporting body is driven by a predetermined angle, so as to take the attitude of connecting only the wheels 16 on the ground, and the robot moves on the wheels 16 through the inverted two (2) wheels control. In this instance, with the conventional robot, a backrush for each joint and positional error due to spring property are accumulated as large as the number of the joints passing through from the wheels 16 to the body 3. For this reason, there is a drawback that the rigidity of the system becomes low, and therefore it is difficult to execute the inverted two (2) wheels control with stability (for example, with the example shown in the Japanese Patent Laying-Open No. 2005-288561 (2005), it passes through five (5) degrees of freedom from the wheels to the body trunk).

According to the embodiment of the present invention, since the joints are three (3) to be passed through, i.e., the first leg actuator 9, the second leg actuator 11 and the third leg actuator 13, therefore it is possible to achieve the inverted two (2) wheels control of high rigidity.

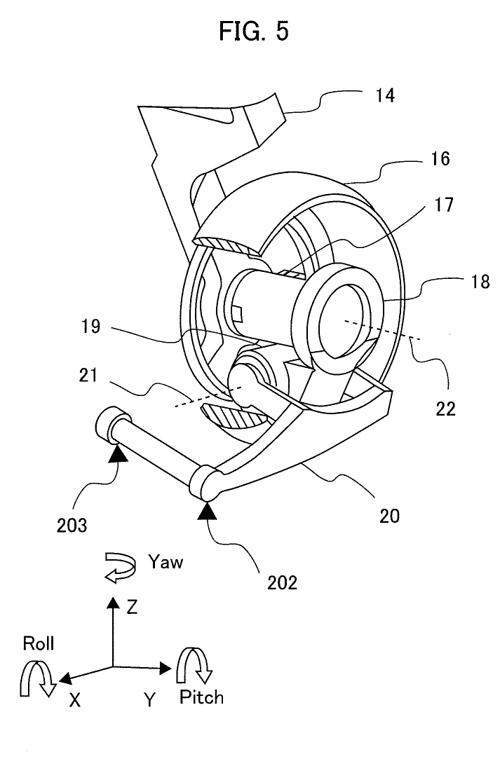

FIG. 5 is a perspective view for explaining the operation of the supporting body of the robot, according to the present embodiment.

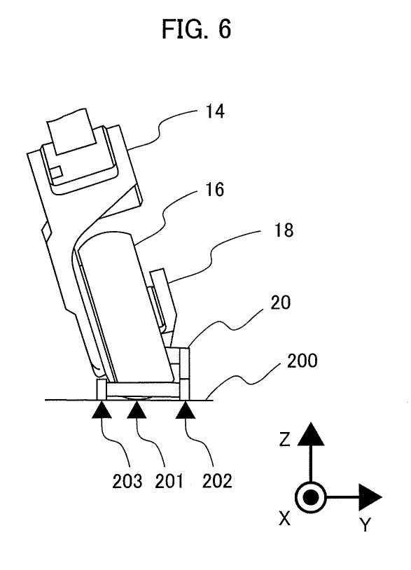

FIG. 6 is a plane view for showing FIG. 4 seeing in the X-axis direction.

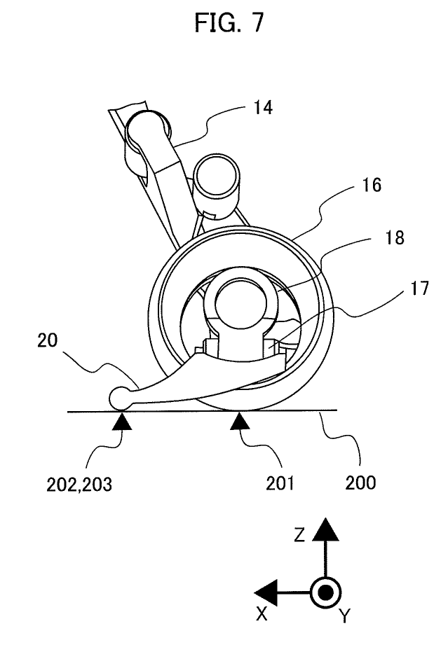

FIG. 7 is a plane view for showing FIG. 4 seeing in the Y-axis direction.

In FIG. 5, without executing the inverted two (2) wheels control, both the supporting body 20 and the wheel 16 are in the attitude of being in contact with the ground with driving the pitch shaft driving actuator 17 of the supporting body by a predetermined angle. As is shown in FIG. 5, the supporting body 20 of the robot 1, according to the present embodiment, is in contact with the ground at the two (2) points, i.e., a first supporting body contacting point 202 and a second supporting body contacting point 203. Since the supporting body 20 has two (2) degrees of freedom, i.e., a roll rotation shaft 21 of the supporting body and a pitch rotation shaft 22 of the supporting body, then it can be controlled so that the wheel 16, the first supporting body contacting point 202 and the second supporting body contacting point 203 are in contact with the ground 200, with certainty, if there is unevenness on the ground a little bit.

Also, in this instance, the supporting convex polygon, being defined by three (3) points, i.e., the contacting point 201 of the wheel on the ground, the first supporting body contacting point 202 and the second supporting body contacting point 203, is called “grounding triangle” in the explanation, which will be given below.

Hereinafter, explanation will be given about the condition that the grounding triangle defined by the contacting point 201 of the wheel on the ground, the first supporting body contacting point 202 and the second supporting body contacting point 203, does not change even if the roll rotation shaft 21 of the supporting body and the pitch rotation shaft 22 take any attitude. Herein, an advantage or merit of that the grounding triangle does not change lies in that, since the stability of ZMP does not change to disturbances if the supporting body takes any attitude, the robot can always maintain a certain or constant stability.

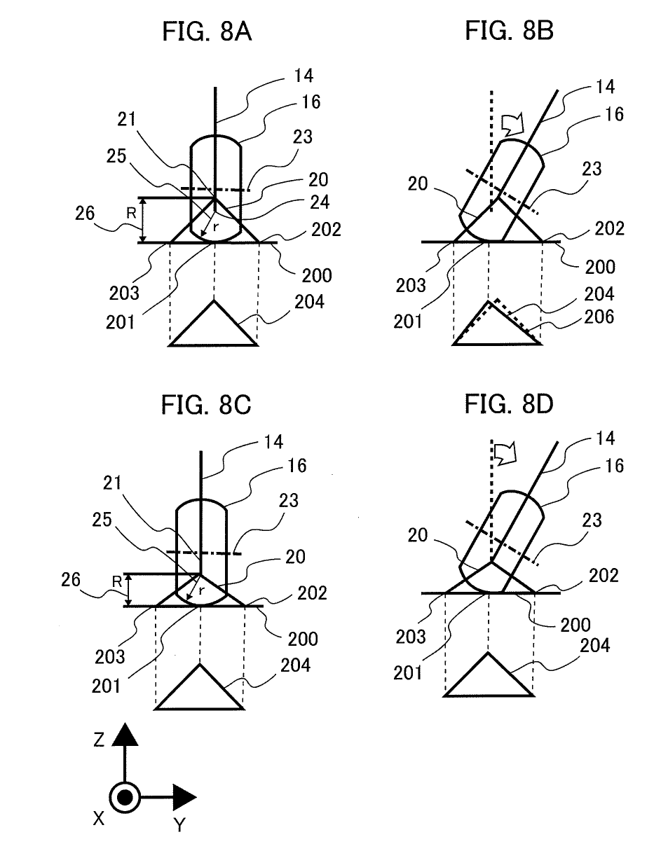

FIGS. 8A to 8D are views for explaining the grounding condition, in particular, when driving the supporting body in the roll direction.

In FIGS. 8A to 8D, a relationship between the position of the roll rotation shaft 21 of the supporting body and a center 24 of the wheel cross-section of the wheel 16 and the size of a radius 25 of the cross-section circle of the wheel, so as not to change the configuration of the grounding triangle 204, which is defined by the contacting point 201 of the wheel on the ground, the first supporting body contacting point 202 and the second supporting body contacting point 203, is as below.

Namely, FIGS. 8A to 8D are views for showing the grounding condition of the wheel 16 and the supporting body 20 of the robot 1, seeing in the X-axis direction. Among those, FIGS. 8A and 8B are views for showing the constructing, in which the roll rotation shaft 21 of the supporting body and the center 24 of the cross-section circle of the wheel are not coincident with, while FIGS. 8C and 8D are views for showing the constructing, in which the roll rotation shaft 21 of the supporting body and the center 24 of the cross-section circle of the wheel are coincident with each other. Also, in this instance, a distance 26 of the roll rotation shaft of the supporting body from the ground is determined in such a manner that the roll rotation shaft 21 of the supporting body is always in parallel with the X-axis when the three (3) points, i.e., the contacting point 201 of the wheel on the ground, the first supporting body contacting point 202 and the second supporting body contacting point 203 are in contact with the ground 200.

FIG. 8A shows an attitude, in which the fourth leg link 14 is in parallel with the Z-axis. In this instance, the grounding triangle 204 is defined by the three (3) points; i.e., the contacting point 201 of the wheel on the ground, the first supporting body contacting point 202 and the second supporting body contacting point 203. FIG. 8B shows the condition where the roll shaft driving actuator 19 of the supporting body is driven by a predetermined angle from the condition shown in FIG. 8A, so as to incline the rotation shaft 23 of the wheel to the ground 200. As apparent from those figures, an apex of the grounding triangle 204 moves, and thereby defines a grounding triangle 205 having a new configuration. Such change of the configuration of the grounding triangle results into a cause of reason of loosing the stability.

FIG. 8C also shows the attitude, in which the fourth leg link 14 is in parallel with the Z-axis, as shown in FIG. 8A. However, they are so constructed that the roll rotation shaft 21 of the supporting body and the center 24 of the cross-section circle of the wheel are coincident with each other. FIG. 8D shows the condition where the roll shaft driving actuator 19 of the supporting body is driven by a predetermined angle from the condition shown in FIG. 8C, so as to incline the rotation shaft 23 of the wheel to the ground 200. In this instance, the grounding triangle 204 does not change the configuration thereof, and therefore no change of the stability between FIG. 8C and FIG. 8D.

Although FIGS. 8A to 8D show an example of the case where the roll rotation shaft 21 of the supporting body and the center 24 of the cross-section circle of the wheel are shifted in the Z-axis direction, but it is apparent that, also in case where they are shifted in the Y-axis direction, the grounding triangle 204 changes the configuration thereof when driving the roll rotation shaft 21 of the supporting body, and therefore the explanation thereof was omitted herein.

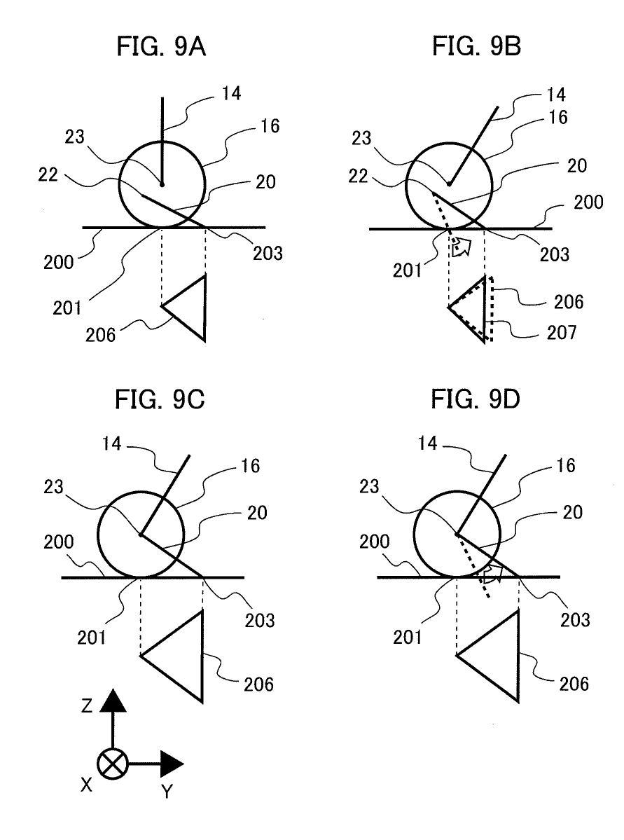

FIGS. 9A to 9D are views for explaining about the grounding condition, in particular, when driving the supporting body in the pitch direction.

FIGS. 9A to 9D are views for showing the grounding condition of the wheel 16 and the supporting body 20 of the robot 1, seeing in the Y-axis direction. Among those, FIGS. 9A and 9B are views for showing the constructing, in which the pitch rotation shaft 22 of the supporting body and the rotation shaft 23 of the wheel are not coincident with, while FIGS. 9C and 9D are views for showing the constructing, in which the pitch rotation shaft 22 of the supporting body and the rotation shaft 23 of the wheel are coincident with each other.

FIG. 9A shows an attitude, in which the fourth leg link 14 is in parallel with the Z-axis. In this instance, the grounding triangle 206 is defined by the three (3) points; i.e., the contacting point 201 of the wheel on the ground, the second supporting body contacting point 203 and the first supporting body contacting point 202 laying in the positive direction of the Y-axis in the figures. FIG. 9B shows the condition where the pitch shaft driving actuator 17 of the supporting body is driven by a predetermined angle from the condition shown in FIG. 9A, so as to incline the fourth leg link 14 to the ground 200. As apparent from those figures, apexes of the grounding triangle 206 move, and thereby define a grounding triangle 207 having a new configuration. Such change of the configuration of the grounding triangle results into a cause of reason of loosing the stability.

FIG. 9C also shows the attitude, in which the fourth leg link 14 is in parallel with the Z-axis, as shown in FIG. 9A. However, they are so constructed that the pitch rotation shaft 22 of the supporting body and the rotation shaft 23 of the wheel are coincident with each other. FIG. 9D shows the condition where the pitch shaft driving actuator 17 of the supporting body is driven by a predetermined angle from the condition shown in FIG. 8C, so as to incline the fourth leg link 14 to the ground 200. In this instance, the grounding triangle 204 does not change the configuration thereof, and therefore no change of the stability between FIG. 9C and FIG. 9D.

As was mentioned above, according to the present invention, the grounding triangle, being defined by the three (3) points, i.e., the contacting point 201 of the wheel on the ground, the first supporting body contacting point 202 and the second supporting body contacting point 203, does not change, even if the driving the roll rotation shaft 21 of the supporting body and the pitch rotation shaft 22 of the supporting body take any attitude.

This condition of no change is because the distance 26 of the roll rotation shaft of the supporting body is determined in such a manner that the roll rotation shaft 21 comes to be always in parallel with the X-axis, when the three (3) points, i.e., the contacting point 201 of the wheel on the ground, the first supporting body contacting point 202 and the second supporting body contacting point 203 are in contact with the ground 200.

Further, it is because the roll rotation shaft 21 of the supporting body and the center 24 of the wheel are constructed to be coincident with, and moreover because the pitch rotation shaft 22 of the supporting body and the rotation shaft 23 of the wheel are constructed to be coincident with each other.

In this manner, if satisfying the condition mentioned above, the supporting convex polygon comes to be constant irrespective of the attitude of the supporting body, and the stability to the disturbance does not change, therefore it is possible to achieve a mechanism having high stability.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications that fall within the ambit of the appended claims.

What is claimed is:

1. A robot, comprising:
a body; and
left and right leg portions in lower portion of said body, wherein
each leg portion has a wheel, which can be drive, at a tip thereof, and a supporting portion, which is movable in roll and pitch directions.

2. The robot, described in the claim 1, wherein
said each leg portion has three (3) degrees of freedom, roll, pitch and pitch from said body side.

3. The robot, described in the claim 1, wherein
said supporting portion has at least two (2) of contact points to be in contact with a ground, and makes up a stable region by a contact point of said wheel and the contact point of said supporting body, and thereby oscillating said left and right leg portions, alternately, so as to make bipedalism, and further operating said supporting body, so as to run on said wheels.

4. The robot, described in the claim 1, wherein
a distance of a roll rotation shaft of said supporting body from a ground is so determined that the roll rotation shaft of said supporting body comes to be in parallel with said ground when at least two (2) points, including, are in contact with the ground, and also said roll rotation shaft of said supporting body and a center of cross-section circle of said roll rotation shaft are constructed to be coincident with, and
a pitch rotation shaft of said supporting body and a rotation shaft of said wheel are constructed to be coincident with each other.
